(19) United States
(12) Patent Application Publication
(10) Pub. No.: US 2021/0331247 A1
(43) Pub. Date: Oct. 28, 2021

(54) METHOD OF PRODUCING ADDITIVELY MANUFACTURED OBJECT AND ADDITIVELY MANUFACTURED OBJECT

(71) Applicant: MITSUBISHI HEAVY INDUSTRIES, LTD., Tokyo (JP)

(72) Inventors: Takahiro TACHIBANA, Tokyo (JP); Noriyuki HIRAMATSU, Tokyo (JP); Tomoko TAMURA, Tokyo (JP)

(21) Appl. No.: 17/235,214

(22) Filed: Apr. 20, 2021

(30) Foreign Application Priority Data
Apr. 28, 2020 (JP) 2020-079086

(51) Int. Cl. B22F 10/64; B33Y 10/00; B33Y 40/20; B33Y 70/00

(52) U.S. Cl. CPC B22F 10/64; B33Y 10/00; B33Y 40/20; B22F 2301/052; B22F 2301/35; B22F 2301/15; B22F 2301/205; B33Y 70/00

(57) ABSTRACT

A method of producing an additively manufactured object comprises: a step of cooling a shaped body of an alloy formed by additive manufacturing to 0° C. or lower; and a step of aging the shaped body under a temperature condition of 400° C. or higher and 600° C. or lower after the step of cooling the shaped body. The alloy contains: Fe as a main component; 17.0 mass % or more and 19.0 mass % or less of Ni; 7.0 mass % or more and 12.5 mass % or less of Co; 4.6 mass % or more and 5.2 mass % or less of Mo; 0.13 mass % or more and 1.6 mass % or less of Ti; and 0.05 mass % or more and 0.15 mass % or less of Al.

### TECHNICAL FIELD

The present disclosure relates to a method of producing an additively manufactured object and an additively manufactured object.

### BACKGROUND

Maraging steel used as a structural material is a steel containing low carbon and a large amount of Ni, Co, and Mo, and it is known that a high strength can be obtained by performing aging treatment after martensite formation.

Patent Document 1 describes that the content of C, Ni, Co, and Mo in maraging steel is in a specific range in order to obtain a forged product of the maraging steel having a tensile strength of 2300 MPa or more and achieving both high ductility and toughness and high fatigue characteristics.

### CITATION LIST

### Patent Literature

Patent Document 1: JP6166953B

### SUMMARY

### Problems to be Solved

According to findings of the present inventors, when a shaped product is formed by additive manufacturing (3D printing) using maraging steel as a material, the strength after aging treatment may be lowered as compared with a forged product of the same material.

In view of the above, an object of at least one embodiment of the present disclosure is to provide a method of producing an additively manufactured object whereby it is possible to improve the strength of an additively manufactured object of maraging steel, and an additively manufactured object of maraging steel with an improved strength.

### Solution to the Problems

A method of producing an additively manufactured object according to at least one embodiment of the present disclosure comprises: a step of cooling a shaped body of an alloy formed by additive manufacturing to 0° C. or lower; and a step of aging the shaped body under a temperature condition of 400° C. or higher and 600° C. or lower after the step of cooling the shaped body.

The alloy contains:

Fe as a main component;

17.0 mass % or more and 19.0 mass % or less of Ni;

7.0 mass % or more and 12.5 mass % or less of Co;

4.6 mass % or more and 5.2 mass % or less of Mo;

0.13 mass % or more and 1.6 mass % or less of Ti; and

0.05 mass % or more and 0.15 mass % or less of Al.

Further, an additively manufactured object according to at least one embodiment of the present disclosure is made of an alloy containing:

Fe as a main component;

17.0 mass % or more and 19.0 mass % or less of Ni;

7.0 mass % or more and 12.5 mass % or less of Co;

4.6 mass % or more and 5.2 mass % or less of Mo;

0.13 mass % or more and 1.6 mass % or less of Ti; and

0.05 mass % or more and 0.15 mass % or less of Al.

The additively manufactured object has a Vickers hardness of 535 Hv or more.

### Advantageous Effects

At least one embodiment of the present disclosure provides a method of producing an additively manufactured object whereby it is possible to improve the strength of an additively manufactured object of maraging steel, and an additively manufactured object of maraging steel with an improved strength.

### BRIEF DESCRIPTION OF DRAWINGS

FIG. 1 is a flowchart of a method of producing an additively manufactured object according to an embodiment.

FIG. 2 is a cross-sectional photograph of an additively manufactured object produced by the production method according to an embodiment.

### DETAILED DESCRIPTION

Embodiments of the present disclosure will now be described in detail with reference to the accompanying drawings. It is intended, however, that unless particularly identified, dimensions, materials, shapes, relative positions, and the like of components described in the embodiments shall be interpreted as illustrative only and not intended to limit the scope of the present disclosure.

(Additively Manufactured Object Production Method)

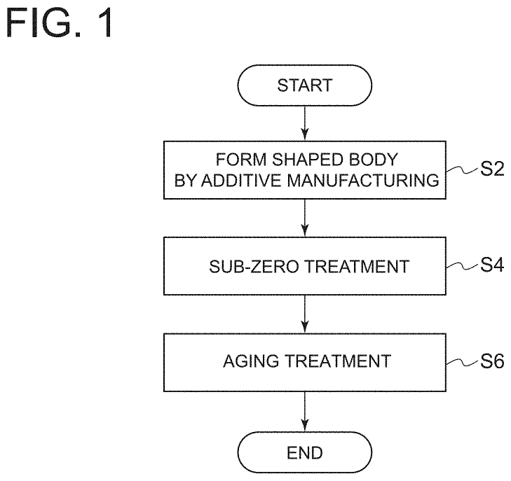

FIG. 1 is a flowchart of a method of producing an additively manufactured object according to an embodiment. As shown in FIG. 1, the method of producing an additively manufactured object includes a step of forming a shaped body of an alloy having the following composition by additive manufacturing (shaping step; S2); a step of cooling the shaped body obtained in step S2 to 0° C. or lower (that is, performing sub-zero treatment) (cooling step; S4); and a step of aging the shaped body after the sub-zero treatment (aging step; S6).

The alloy forming the shaped body contains:

Fe (iron) as a main component;

17.0 mass % or more and 19.0 mass % or less of Ni (nickel);

7.0 mass % or more and 12.5 mass % or less of Co (cobalt);

4.6 mass % or more and 5.2 mass % or less of Mo (molybdenum);

0.13 mass % or more and 1.6 mass % or less of Ti (titanium); and

0.05 mass % or more and 0.15 mass % or less of Al (aluminum).

In some embodiments, the alloy may contain:

Fe as a main component;

18.0 mass % or more and 19.0 mass % or less of Ni;

8.5 mass % or more and 12.5 mass % or less of Co;

4.6 mass % or more and 5.2 mass % or less of Mo;

0.5 mass % or more and 1.6 mass % or less of Ti; and

0.05 mass % or more and 0.15 mass % or less of Al.

Components other than Ni, Co, Mo, Ti and Al in the alloy constituting the additively manufactured object in some embodiments may be only Fe, which is the main component, and unavoidable impurities. The unavoidable impurities may include: 0.03 mass % or less of C (carbon); 0.10 mass % or less of Mn (manganese); 0.10 mass % or less of Si (silicon); 0.01 mass % or less of P (phosphorus); 0.01 mass % or less of S (sulfur); 0.50 mass % or less of Cr (chromium); or 0.50 mass % or less of Cu (copper).

The alloy having the above-described composition is included in special steels generally called maraging steels. The alloy having the above-described composition is commercially available in the form of powder or the like, and can be used as a material in additive manufacturing.

Ni, Mo, Ti, and Al of components constituting the alloy are elements constituting precipitates that contribute to age hardening. These elements are precipitated as fine crystals of intermetallic compounds or the like by the aging treatment in the aging step (S6), and contribute to the improvement of the strength of metal. Further, Co of components constituting the alloy has a role of lowering the solid solution limit of Mo and promoting the precipitation of Mo during the aging treatment in the aging step (S6).

(Shaping Step; S2)

In the shaping step S2, a shaped body made of the alloy having the above-described composition is formed by additive manufacturing. As the method of additive manufacturing, the powder bed fusion (PBF) method (hereinafter, also referred to as PBF method) or the directed energy deposition (DED) method (hereinafter, also referred to as DED method) may be adopted.

In the PBF method, metal powder is spread, a part to be built is selectively melt and solidified with a laser or an electron beam as a heat source, and this process is repeated to form a shaped body having a desired shape. Herein, of the shaped body formed by the PBF method and the additively manufactured object obtained by subjecting the shaped body to heat treatment, a portion obtained by a single process of spreading metal powder and melting and solidifying the metal with a laser or an electron beam (that is, one of laminated layers) is referred to as a bead. In other words, the shaped body or the additively manufactured object is an aggregate of beads.

In the DED method, supply of metal powder and irradiation with a laser or an electron beam as a heat source are performed at the same time so that the metal powder is melted and solidified at a predetermined position layer by layer to form a shaped body having a desired shape. Herein, of the shaped body formed by the DED method and the additively manufactured object obtained by subjecting the shaped body to heat treatment, a portion obtained by a single process (one pass) of irradiating metal powder with a heat source to melt and solidify the metal is referred to as a bead. In other words, the shaped body or the additively manufactured object is aggregates of beads.

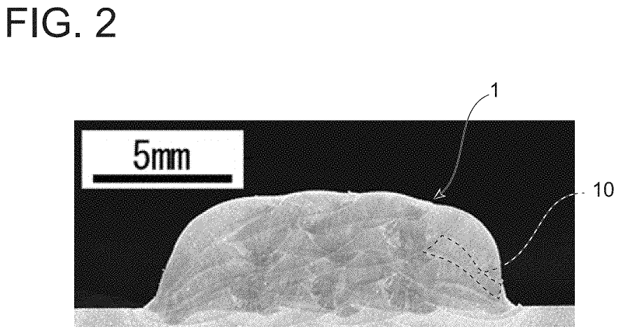

In a cross-section of the shaped body formed by additive manufacturing and the additively manufactured object according to some embodiments, a scaly metallographic structure is observed for example as shown in FIG. 2. FIG. 2 is a cross-sectional photograph of the additively manufactured object produced by the production method according to an embodiment. The additively manufactured object 1 shown in FIG. 1 is manufactured by the DED method. One scaly piece shown in the cross-sectional photograph of FIG. 2 corresponds to the cross-section of one bead 10. The cross-sectional photograph of FIG. 2 is a photograph showing a cross-section substantially perpendicular to the length direction of a plurality of beads 10 (the moving direction of a heat source such as a laser or an electron beam at the time of shaping). As shown in FIG. 2, in a typical shaped body and additively manufactured object obtained by the DED method, the beads are stacked in the vertical direction (or the thickness direction of the beads) and the horizontal direction (or the width direction of the beads). In the case of the DED method, each bead may have a width of 1 mm or more and 15 mm or less.

(Cooling Step; S4)

In the cooling step (S4), the shaped body of the alloy shaped in the shaping step (S2) is cooled to 0° C. or lower (that is, sub-zero treatment is performed). In the cooling step (S4), for example, the shaped body may be immersed in liquid nitrogen to cool the shaped body. The time for immersing the shaped body in liquid nitrogen may be 30 minutes or more, for example, about 1 hour. In an embodiment, in the cooling step (S4), the shaped body may be cooled to −130° C. or lower, or −160° C. or lower.

Generally, due to the characteristics of additive manufacturing, it is considered that when the metal powder melted is rapidly cooled and solidified during the formation of the beads (or layers), martensite formation occurs in the metal structure, which improves the strength of the material. However, in the case of the alloy (maraging steel) having the above-described composition, the shaped product produced by additive manufacturing has a low strength compared with the forged product. The reason may be that the alloy having the above-described composition contains many additives, so the Mf point at which martensite formation is completed is decreased, and heat is input again at the time of formation of an upper layer before it is cooled to a temperature below the Mf point by quenching during the shaping, so that martensite is transformed into austenite, which has a low strength. In addition, in the shaped body formed by additive manufacturing, the grain boundary segregation of strengthening elements (Ni, Ti, Mo) occurs more significantly than in the forged body, so that the strengthening elements are decreased in the grains to be strengthened. It is also considered to be one of the factors that reduce the strength relatively.

It is known that, when the structure of iron alloy is rapidly cooled and transformed from austenite into martensite, the Ms point, which is the temperature at which martensite formation starts, and the Mf point, which is the temperature at which martensite formation is completed, change depending on the C content in the alloy. However, actually, they are also affected by the content of components other than C. For example, the Ms point and the Mf point tend to decrease as the content of Ni or Mo of the elements constituting the alloy increases. Further, the Ms point and the Mf point tend to increase as the content of Co or Al increases. In the alloy (maraging steel) having the above-described composition, since the content of Ni and Mo is relatively high, it is considered that the Ms point and the Mf point are unexpectedly decreased compared with other types of steels.

In this regard, by rapidly cooling the shaped body of the alloy having the above-described composition by performing the sub-zero treatment in the cooling step (S4), retained austenite generated during the additive manufacturing in the shaping step (S2) can be transformed into martensite which has a higher strength. Thus, it is possible to improve the strength of the additively manufactured object as compared with the case where the sub-zero treatment is not performed.

(Aging Step; S6)

In the aging step (S6), the shaped body after the cooling step (S4) is aged under a temperature condition of 400° C. or higher and 600° C. or lower. In the aging step (S6), for example, after the shaped body is heated for 2 hours or more in the above-described temperature range, the shaped body may be air-cooled.

By performing the aging treatment, components such as Ni, Mo, Ti, and Al in the alloy forming the shaped body are precipitated as fine crystals of intermetallic compounds or the like, so that the strength of the metal can be improved.

Thus, by subjecting the shaped body formed by additive manufacturing to the aging treatment in the aging step (S6) after the sub-zero treatment in the step (S4), it is possible to obtain an additively manufactured object of maraging steel having a higher strength than the conventional one.

In some embodiments, after forming the shaped body in the shaping step (S2), the cooling step (S4) (that is, sub-zero treatment of the shaped body) is performed without solution treatment of the shaped body. In the solution treatment, for example, heat treatment is performed at a temperature of 700° C. or higher and 900° C. or lower. This heat treatment may be performed in a vacuum furnace. After the shaped body is heated for 30 minutes or more in this temperature range, the shaped body may be air-cooled.

In the case where the solution treatment is performed after the formation of the shaped body by forging or the like (for example, Patent Document 1), since the alloy structure is transformed to the austenite phase, the sub-zero treatment is necessarily performed after the solution treatment in order to transform the structure to martensite. In contrast, as in the above-described embodiment, in the case where the solution treatment of the shaped body formed by additive manufacturing is not performed, generally, since the martensite phase generated in the thermal history of the additive manufacturing is retained as it is, the sub-zero treatment does not have to be necessarily performed. However, in fact, as already described, in the case of the alloy (maraging steel) having the above-described composition, reverse transformation to the austenite phase may occur due to heat input for the formation of subsequent layers during the shaping by addition manufacturing. Therefore, it is meaningful to perform the sub-zero treatment of the shaped body. In this regard, in the above-described embodiment, since the sub-zero treatment is performed on the shaped body that has not undergone the solution treatment, it is possible to impart appropriate strength to the additively manufactured object.

(Characteristics of Additively Manufactured Object)

The additively manufactured object produced by the production method including the cooling step (S4) and the aging step (S6) typically has a Vickers hardness of 535 Hv or more, and thus has a relatively high strength as the additively manufactured object made of maraging steel having the above-described composition.

The additively manufactured object produced by the production method including the cooling step (S4) and the aging step (S6) typically has a 0.2% proof stress of 1860 MPa or more, and thus has a relatively high strength as the additively manufactured object made of maraging steel having the above-described composition.

The additively manufactured object produced by the production method including the cooling step (S4) and the aging step (S6) typically has a tensile strength of 1900 MPa or more, and thus has a relatively high strength as the additively manufactured object made of maraging steel having the above-described composition.

The Vickers hardness described herein is measured in accordance with JIS Z 2244. The value [Hv] of Vickers hardness described herein is measured with a test force of 200 gf. Further, the 0.2% proof stress and the tensile strength described herein are measured in accordance with JIS Z 2241.

The additively manufactured object produced by the production method including the cooling step (S4) and the aging step (S6) typically contains less than 2 vol % retained austenite. Specifically, according to the above-described production method, by performing the sub-zero treatment in the cooling step (S4) after additive manufacturing, retained austenite that can occur during the process of additive manufacturing is reduced by transformation to higher-strength martensite, so that the content of retained austenite is reduced to typically less than 2 vol %. Thus, it is possible to obtain an additively manufactured object with a relatively high strength.

The content of retained austenite in the additively manufactured object can be calculated based on the intensity of a peak indicated by austenite contained in an X-ray diffraction chart of the additively manufactured object.

In the additively manufactured object produced by the above-described production method, each of the beads may have a cross-sectional area (cross-sectional area perpendicular to the length direction of the beads) of 0.25 mm² or more and 20 mm² or less, or 1.0 mm² or more and 10 mm² or less. When the DED method is adopted as the method of additive manufacturing, the cross-sectional area of the beads tends to be larger than that in the PBF method, and the cross-sectional area is usually in the above range.

The larger the cross-sectional area of the beads constituting the additively manufactured object, the more difficult it is to cool the beads during the additive manufacturing, and therefore the more difficult it is to transform to martensite. In this regard, as described above, even if each bead has a relatively large cross-sectional area of 0.25 mm² or more and 20 mm² or less or, 1.0 mm² or more and 10 mm² or less and thus has a structure that is difficult to form martensite during additive manufacturing, with the production method including the cooling step (S4) and the aging step (S6), it is possible to obtain an additively manufactured object with a relatively high strength.

The cross-sectional area per bead can be calculated from the size of the area occupied by the cross-section of one bead, or by dividing the area of the entire cross-section of the additively manufactured object by the number of beads, based on the cross-sectional photograph for example as shown in FIG. 2.

### EXAMPLES

Shaped bodies were formed by the DED method using materials (maraging steels) having different compositions, and the shaped bodies were heat-treated under various heat treatment conditions to obtain additively manufactured objects of Examples 1 to 10. The Vickers hardness and retained austenite content were measured for each of the additively manufactured objects of the examples.

(Composition of Material)

As shown in Table 1 below, the shaped bodies and additively manufactured objects according to Examples 1 to 9 were made of material A (alloy powder) shown below, and the shaped body and additively manufactured object according to Example 10 were made of material B (alloy powder) shown below.

Material A: (Standard composition: Main component Fe, 18 mass % Ni, 9 mass % Co, 5 mass % Mo, 0.9 mass % Ti and Al in total, and unavoidable impurities)

Material B: (Standard composition: Main component Fe, 18 mass % Ni, 12 mass % Co, 4 mass % Mo, 1.7 mass % Ti, 0.1 mass % Al, and unavoidable impurities)

TABLE 1

| | | Heat treatment condition | | | | | Retained |
|---|---|---|---|---|---|---|---|
| | | Solution | Sub-zero | Re-heat | Aging | Hardness | austenite |
| | Material | treatment | treatment | treatment | treatment | [Hv] | [Vol %] |
| Example 1 | A | ✓ | — | — | ✓ | 530.8 | 2.5 |
| Example 2 | A | — | ✓ | — | — | 345.5 | 1.0 |
| Example 3 | A | — | ✓ | — | ✓ | 562.4 | 0.5 |
| Example 4 | A | ✓ | — | 800° C. | ✓ | 504.5 | 7.6 |
| Example 5 | A | ✓ | — | 750° C. | ✓ | 462.6 | 10.1 |
| Example 6 | A | ✓ | — | 700° C. | ✓ | 385.6 | 22.6 |
| Example 7 | A | ✓ | — | 650° C. | ✓ | 393.6 | 43.0 |
| Example 8 | A | ✓ | — | 600° C. | ✓ | 506.3 | 5.8 |
| Example 9 | A | — | — | — | ✓ | 514.4 | 2.0 |
| Example 10 | B | — | ✓ | — | ✓ | 653.0 | n/a |

(Shaping Condition)

The shaped bodies according to Examples 1 to 10 were obtained by the DED method, using the material A or the material B, with a laser metal deposition (LIVID) device, by using a parent material (18Ni maraging steel 300G) as a base material. The shaping conditions are as follows.

Laser output: 4 kW

Shaping speed: 1 m/min

Beam system: φ4 mm

Powder supply amount: 25 g/min

No preheating, interpass temperature was lower than 200° C.

(Heat Treatment Condition)

The shaped bodies according to Examples 1 to 10 were subjected to heat treatment shown in Table 1, specifically at least one of solution treatment, sub-zero treatment, re-heat treatment, and aging treatment in this order. The check mark in Table 1 indicates that each heat treatment was performed, and “-” indicates that each heat treatment was not performed. Further, the temperature in the column of “re-heat treatment” indicates the temperature at which the re-heat treatment was performed. The conditions of each heat treatment are as follows.

(a) Solution Treatment

The shaped body was heated in a vacuum furnace at 820° C. for 1 hour and then air-cooled.

### (b) Sub-Zero Treatment (Corresponding to Process in Cooling Step (S4))

The shaped body was immersed in liquid nitrogen at −198° C. for 1 hour and then removed from liquid nitrogen.

### (c) Re-Heat Treatment

The shaped body was heated in an atmosphere furnace under temperature conditions shown in Table 1 (600° C. to 800° C.) for 5 minutes, and then air-cooled. This re-heat treatment was performed in order to simulate the heat effect received during shaping with DED.

### (d) Aging Treatment (Corresponding to Process in Aging Step (S6))

The shaped body was heated in a vacuum furnace at 480° C. for 5 hours and then slowly cooled.

Of Examples 1 to 10, Examples 3 and 10 subjected to the sub-zero treatment and the aging treatment correspond to examples according to an embodiment of the present disclosure.

(Characteristic Test of Additively Manufactured Object)

The Vickers hardness and retained austenite content of the additively manufactured objects according to Examples 1 to 10 obtained by the heat treatment were measured.

(Measurement of Vickers Hardness)

The Vickers hardness was measured in accordance with JIS Z 2244 with a test force of 200 gf.

(Measurement of Retained Austenite Content)

The content of retained austenite was calculated based on the intensity of a peak indicated by austenite in an X-ray diffraction chart obtained by X-ray diffraction test on each additively manufactured object with the following conditions and device. The content of retained austenite of Example 10 was not measured.

Measurement device: micro X-ray stress estimation device, AutoMATE II, manufactured by Rigaku Corporation.

Measurement conditions: Cr, tube voltage 40 kV, tube current 40 mA, collimator φ2 mm, R value 0.25371

(Result)

As shown in Table 1, the additively manufactured object according to Example 3, in which the shaped body made of the material A was subjected to the sub-zero treatment and the aging treatment, had a hardness of 562.4 Hv, which is higher than those of the additively manufactured objects according to the other examples (Examples 1, 2, and 4 to 9) made of the same material (material A). Further, the additively manufactured object according to Example 3 contains 0.5 vol % of retained austenite, which is significantly less than those of the additively manufactured objects according to the other examples (Examples 1, 2, and 4 to 9) made of the same material (material A).

It can be inferred from this result that, in Example 3 in which the sub-zero treatment was performed, since the shaped body was rapidly cooled, transformation from retained austenite generated during the shaping to martensite was promoted as compared with the other examples in which the sub-zero treatment was not performed, so that the strength of the resulting additively manufactured object was improved.

In addition, as shown in Table 1, the additively manufactured object according to Example 10, in which the shaped body made of the material B was subjected to the sub-zero treatment and the aging treatment, had a hardness of 653 Hv, which is higher than that of the additively manufactured object according to Example 3 subjected to the same heat treatment.

It is presumed that if the material B is subjected to the same heat treatment as in Examples 2 to 9, the same tendency as that of the material A can be obtained. Specifically, it is presumed that Example 10 would have higher strength and a lower content of retained austenite than those of other additively manufactured objects made of the same material (material B).

It is also considered that, in the additively manufactured object according to Example 10 which was made of the material B and subjected to the sub-zero treatment, as with the case of the material A (Example 3), the shaped body was rapidly cooled, and transformation from retained austenite generated during the shaping to martensite was promoted, so that the strength of the resulting additively manufactured object was improved.

The contents described in the above embodiments would be understood as follows, for instance.

(1) A method of producing an additively manufactured object according to at least one embodiment of the present disclosure comprises: a step of cooling a shaped body of an alloy formed by additive manufacturing to 0° C. or lower (for example, the above-described cooling step S4); and a step of aging the shaped body under a temperature condition of 400° C. or higher and 600° C. or lower after the step of cooling the shaped body (for example, the above-described aging step S6).

The alloy contains:

Fe as a main component;

17.0 mass % or more and 19.0 mass % or less of Ni;

7.0 mass % or more and 12.5 mass % or less of Co;

4.6 mass % or more and 5.2 mass % or less of Mo;

0.13 mass % or more and 1.6 mass % or less of Ti; and

0.05 mass % or more and 0.15 mass % or less of Al.

Generally, due to the characteristics of additive manufacturing, it is considered that when the metal powder melted is rapidly cooled and solidified during the formation of the beads (or layers), martensite formation occurs in the metal structure, which improves the strength of the material. However, in the case of the alloy (maraging steel) having the above-described composition, the shaped product produced by additive manufacturing has a low strength compared with the forged product. The reason may be that the alloy having the above-described composition contains many additives, so the Mf point at which martensite formation is completed is decreased, and heat is input again due to formation of an upper layer before it is cooled to a temperature below the Mf point by quenching during the shaping, so that martensite is transformed into austenite, which has a low strength. In this regard, according to the above method (1), by cooling the shaped alloy to 0° C. or lower (that is, performing the sub-zero treatment), retained austenite generated during the additive manufacturing can be transformed into martensite which has a higher strength. Thus, it is possible to improve the strength of the additively manufactured object as compared with the case where the sub-zero treatment is not performed.

(2) In some embodiments, in the above method (1), the step of cooling the shaped body is performed after formation of the shaped body without solution treatment of the shaped body.

In the case where the solution treatment is performed after the formation of the shaped body by forging or the like (for example, Patent Document 1), since the alloy structure is transformed to the austenite phase, the sub-zero treatment is necessarily performed after the solution treatment in order to transform the structure to martensite. In contrast, as in the above method (2), in the case where the solution treatment of the shaped body formed by additive manufacturing is not performed, generally, since the martensite phase generated in the thermal history of the additive manufacturing is retained as it is, the sub-zero treatment does not have to be necessarily performed. However, in fact, as described in the above (1), in the case of the alloy having the above-described composition, reverse transformation to the austenite phase may occur due to heat input for the formation of subsequent layers during the shaping by addition manufacturing. Therefore, it is meaningful to perform the sub-zero treatment of the shaped body. In this regard, in the above method (2), since the sub-zero treatment is performed on the shaped body that has not undergone the solution treatment, it is possible to impart appropriate strength to the additively manufactured object.

(3) In some embodiments, in the above method (1), the step of cooling the shaped body includes cooling the shaped body to −130° C. or lower, or −160° C. or lower.

According to the above method (3), by cooling the shaped alloy to −130° C. or lower, or −160° C. or lower, retained austenite generated during the additive manufacturing can be more effectively transformed into martensite which has a higher strength. Thus, it is possible to improve the strength of the additively manufactured object as compared with the case where the sub-zero treatment is not performed.

(4) In some embodiments, in any one of the above methods (1) to (3), the alloy contains:

Fe as a main component;

18.0 mass % or more and 19.0 mass % or less of Ni;

8.5 mass % or more and 12.5 mass % or less of Co;

4.6 mass % or more and 5.2 mass % or less of Mo;

0.5 mass % or more and 1.6 mass % or less of Ti; and

0.05 mass % or more and 0.15 mass % or less of Al.

According to the above method (2), as described in the above (1), for the alloy (maraging steel) having the above-described composition, by cooling the shaped alloy to 0° C. or lower (that is, performing the sub-zero treatment), retained austenite generated during the additive manufacturing can be transformed into martensite which has a higher strength. Thus, it is possible to improve the strength of the additively manufactured object as compared with the case where the sub-zero treatment is not performed.

(5) An additively manufactured object according to at least one embodiment of the present disclosure is made of an alloy containing:

Fe as a main component;

17.0 mass % or more and 19.0 mass % or less of Ni;

7.0 mass % or more and 12.5 mass % or less of Co;

4.6 mass % or more and 5.2 mass % or less of Mo;

0.13 mass % or more and 1.6 mass % or less of Ti; and

0.05 mass % or more and 0.15 mass % or less of Al.

The additively manufactured object has a Vickers hardness of 535 Hv or more.

According to the above configuration (5), since the Vickers hardness of the additively manufactured object made of the alloy (maraging steel) having the above-described composition is 535 Hv or more, it is possible to obtain an additively manufactured object with a relatively high strength.

(6) In some embodiments, in the above configuration (5), a content of retained austenite is less than 2 vol %.

According to the above configuration (6), the content of retained austenite in the additively manufactured object made of alloy having the above-described composition is less than 2 vol %. Thus, since retained austenite that can occur during the process of additive manufacturing is reduced by transformation to higher-strength martensite to less than 2 vol %, it is possible to obtain an additively manufactured object with a relatively high strength.

(7) In some embodiments, in the above configuration (5) or (6), the additively manufactured object is an aggregate of beads of the alloy.

In the additively manufactured object which is an aggregate of beads, due to the characteristics of additive manufacturing, it is considered that when the metal powder melted is rapidly cooled and solidified during the formation of the beads, martensite formation occurs in the metal structure, which improves the strength of the material. However, in the case of the alloy (maraging steel) having the above-described composition, the shaped product produced by additive manufacturing has a low strength compared with the forged product. The reason may be that the alloy having the above-described composition contains many additives, so the Mf point at which martensite formation is completed is decreased, and heat is input again at the time of formation of an upper layer before it is cooled to a temperature below the Mf point by quenching during the shaping, so that martensite is transformed into austenite, which has a low strength. In this regard, according to the above configuration (7), since the Vickers hardness of the aggregate of the beads (additively manufactured object) made of the alloy (maraging steel) having the above-described composition is 535 Hv or more, it is possible to obtain an additively manufactured object with a relatively high strength.

(8) In some embodiments, in the above configuration (7), each of the beads has a cross-sectional area of 0.25 mm² or more and 20 mm² or less.

The larger the cross-sectional area of the beads constituting the additively manufactured object, the more difficult it is to cool the beads during the additive manufacturing, and therefore the more difficult it is to transform to martensite. In this regard, according to the above configuration (8), even if each bead has a relatively large cross-sectional area of 0.25 mm² or more and 20 mm² or less and thus the additively manufactured object has a structure that is difficult to form martensite during additive manufacturing, as described in the above (7), it is possible to obtain an additively manufactured object with a relatively high strength.

(9) In some embodiments, in the above configuration (7) or (8), each of the beads has a width of 1 mm or more and 15 mm or less.

According to the above configuration (9), even if each bead has a relatively large width of 1 mm or more and 15 mm or less and thus the additively manufactured object has a structure that is difficult to form martensite during additive manufacturing, as described in the above (7), it is possible to obtain an additively manufactured object with a relatively high strength.

(10) In some embodiments, in any one of the above configurations (5) to (9), the additively manufactured object has a 0.2% proof stress of 1860 MPa or more.

According to the above configuration (10), since the 0.2% proof stress of the additively manufactured object made of the alloy (maraging steel) having the above-described composition is 1860 MPa or more, it is possible to obtain an additively manufactured object with a relatively high strength.

(11) In some embodiments, in any one of the above configurations (5) to (10), the additively manufactured object has a tensile strength of 1900 MPa or more.

According to the above configuration (11), since the tensile strength of the additively manufactured object made of the alloy (maraging steel) having the above-described composition is 1900 MPa or more, it is possible to obtain an additively manufactured object with a relatively high strength.

Embodiments of the present disclosure were described in detail above, but the present disclosure is not limited thereto, and various amendments and modifications may be implemented.

Further, in the present specification, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

1. A method of producing an additively manufactured object, comprising:
a step of cooling a shaped body of an alloy formed by additive manufacturing to 0° C. or lower; and
a step of aging the shaped body under a temperature condition of 400° C. or higher and 600° C. or lower after the step of cooling the shaped body,
wherein the alloy contains:
Fe as a main component;
17.0 mass % or more and 19.0 mass % or less of Ni;
7.0 mass % or more and 12.5 mass % or less of Co;
4.6 mass % or more and 5.2 mass % or less of Mo;
0.13 mass % or more and 1.6 mass % or less of Ti; and
0.05 mass % or more and 0.15 mass % or less of Al.

2. The method according to claim 1,
wherein the step of cooling the shaped body is performed after formation of the shaped body without solution treatment of the shaped body.

3. The method according to claim 1,
wherein the step of cooling the shaped body includes cooling the shaped body to −130° C. or lower, or −160° C. or lower.

4. The method according to claim 1,
wherein the alloy contains:
Fe as a main component;
18.0 mass % or more and 19.0 mass % or less of Ni;
8.5 mass % or more and 12.5 mass % or less of Co;
4.6 mass % or more and 5.2 mass % or less of Mo;
0.5 mass % or more and 1.6 mass % or less of Ti; and
0.05 mass % or more and 0.15 mass % or less of Al.

5. An additively manufactured object, made of an alloy,
wherein the alloy contains:
Fe as a main component;
17.0 mass % or more and 19.0 mass % or less of Ni;
7.0 mass % or more and 12.5 mass % or less of Co;
4.6 mass % or more and 5.2 mass % or less of Mo;
0.13 mass % or more and 1.6 mass % or less of Ti; and
0.05 mass % or more and 0.15 mass % or less of Al, and
wherein the additively manufactured object has a Vickers hardness of 535 Hv or more.

6. The additively manufactured object according to claim 5,
wherein a content of retained austenite is less than 2 vol %.

7. The additively manufactured object according to claim 5,
wherein the additively manufactured object is an aggregate of beads of the alloy.

8. The additively manufactured object according to claim 7,
wherein each of the beads has a cross-sectional area of 0.25 mm² or more and 20 mm² or less.

9. The additively manufactured object according to claim 7,
wherein each of the beads has a width of 1 mm or more and 15 mm or less.

10. The additively manufactured object according to claim 5, which has a 0.2% proof stress of 1860 MPa or more.

11. The additively manufactured object according to claim 5, which has a tensile strength of 1900 MPa or more.
